(19) United States
(12) Patent Application Publication
(10) Pub. No.: US 2026/0291270 A1
(43) Pub. Date: Sep. 24, 2026

(54) CHARGING CONTROL METHOD AND SYSTEM, AND TERMINAL DEVICE, CHARGER AND STORAGE MEDIUM

(71) Applicant: ZTE CORPORATION, Shenzhen (CN)

(72) Inventor: Qingli ZHANG, Shenzhen (CN)

(21) Appl. No.: 18/713,015

(22) PCT Filed: Oct. 14, 2022
(86) PCT No.: PCT/CN2022/125389

§ 371 Date: May 13, 2026

(30) Foreign Application Priority Data
Nov. 25, 2021 (CN) 202111414485.5

(51) Int. Cl. H02J 7/94; H02J 7/61; H02J 7/80; H02J 7/90; H02J 7/96

(52) U.S. Cl. CPC H02J 7/94; H02J 7/80; H02J 7/933; H02J 7/96; H02J 7/61

(57) ABSTRACT

Disclosed are a method for charging control, a system, and a terminal device, a charger and a storage medium. The method may include acquiring maximum charging power value of the charger; acquiring a first current value according to the maximum charging power value and a preset charging data table; and the first current value is a maximum value of current that the charger charged into the battery; determining a target cutoff current value from the first plurality of sample cutoff current values according to the first current value; determining a target cutoff voltage value according to the target cutoff current value; and charging the battery according to the target cutoff current value and the target cutoff voltage value.

### CROSS-REFERENCE TO RELATED APPLICATION

This application is a national stage filing under 35 U.S.C. § 371 of international application number PCT/CN2022/125389, filed Oct. 14, 2022, which claims priority to Chinese patent application No. 202111414485.5 filed Nov. 25, 2021. The contents of these applications are incorporated herein by reference in their entirety.

### TECHNICAL FIELD

The present disclosure relates to the field of charging, and in particular to a method for charging control, a system, a terminal device, a charger, and a storage medium.

### BACKGROUND

When the traditional battery is charged according to the set cutoff voltage and cutoff current, although the battery can be charged quickly in the constant current stage, but the actual constant voltage charging stage is too long. As a result, the charging can be fast in an early stage, but it can still take a long time to complete the charging. In order to solve this problem, smart terminal devices supporting fast charging generally adopt Full Charge Capacity (FCC) charging mode of increasing the maximum charging voltage and the cutoff current. In this way, the stage of constant current charging can be prolonged, and the stage of constant voltage charging and thus the total charging time is shortened.

However, in the present method for charging control, the same cutoff voltage and cutoff current are applied to different chargers. Overcharging or undercharging may occur, when the battery of a terminal device is charged with a charger that does not match the terminal device. For example, when a mobile terminal supports fast charging, the cutoff voltage and cutoff current set for fast charging are still applied to a charger with a small output power, a deviation of the actual charged power may occur, and the battery life and user experience are affected.

### SUMMARY

The following is a summary of the subject matter described herein. This summary is not intended to limit the scope of protection of the claims.

Provided are a method for charging control, a system, a terminal device, a charger, and a storage medium in some embodiments.

Voltage and current mentioned in the present disclosure refer to voltage value and current value respectively.

According to an embodiment of the present disclosure, a method for charging control is provided. The method is applied to a system for charging control connected with a charger and a battery respectively. The method may include: acquiring maximum charging power value of the charger; acquiring a first current value according to the maximum charging power value and a preset charging data table; where the preset charging data table may include a first plurality of sample cut-off current values and a first plurality of sample cut-off voltage values corresponding to a target battery capacity value; the first current value is the maximum value of current that the charger charged into the battery; determining a target cutoff current value from the first plurality of sample cutoff current values according to the first current value; where the target cutoff current value is less than the first current value; determining a target cutoff voltage value according to the target cutoff current value; where the target cutoff voltage value is a sample cutoff voltage value corresponding to the target cutoff current value; and charging the battery according to the target cutoff current value and the target cutoff voltage value.

According to another embodiment of the present disclosure, a system for charging control is provided. The system may include a memory, a processor and a computer program stored in the memory and executable by the processor which, when executed by the processor causes the processor to carry out the method as described above.

According to yet another embodiment of the present disclosure, a terminal device is provided. The terminal device may include the system as described above.

According to yet another embodiment of the present disclosure, a charger is provided. The charger may include the system as described above.

According to yet another embodiment of the present disclosure, a computer-readable storage medium is provided. The computer-readable storage medium stores a computer-executable instruction which, when executed by a processor causes the processor to carry out the method as described above.

Further features and advantages of present disclosure will be illustrated in the subsequent description. The objects and other advantages of the present disclosure can be achieved and obtained by the structure particularly set forth in the description, claims and drawings.

### BRIEF DESCRIPTION OF DRAWINGS

The drawings are intended to provide a further understanding of the technical scheme of the present disclosure, and constitute a part of the specification, and they are intended to illustrate the technical scheme of the present disclosure in conjunction with the embodiments of the present disclosure, but are not intended to limit the technical scheme of the present disclosure.

FIG. 1 depicts a flow chart showing a method for charging control according to an embodiment of the present disclosure;

FIG. 2 depicts a flow chart showing a method for charging control according to another embodiment of the present disclosure to acquire the first current value under the condition that only the data corresponding to the target capacity presents in the charging data table;

FIG. 3 depicts a flow chart showing a method for charging control according to yet another embodiment of the present disclosure to acquire the first current value under the condition that the data corresponding to the further capacity presents in addition to the target capacity in the charging data table;

FIG. 4 depicts a flow chart showing a determination of a target cutoff current value in a method for charging control according to yet another embodiment of the present disclosure;

FIG. 5 depicts a flowchart showing the generation of a charging data table in a method for charging control according to yet another embodiment of the present disclosure;

FIG. 6 depicts a flow chart showing a processing according to a charging data table in a method for charging control when the charger is a fast charging charger, according to yet another embodiment of the present disclosure;

FIG. 7 depicts a flow chart showing a processing according to a preset parameter in a method for charging control when the charger is a fast charging charger, according to yet another embodiment of the present disclosure;

FIG. 8 depicts an example diagram showing a charging control by a method for charging control according to yet another embodiment of the present disclosure; and

FIG. 9 depicts a schematic diagram showing a system for charging control according to yet another embodiment of the present disclosure.

### DETAILED DESCRIPTION

The purpose, technical scheme and advantages of the present disclosure will become apparent through the following description for various embodiments in conjunction with the drawings. It should be understood that the embodiments described here are intended for illustration but not limitation of the present disclosure.

Although the system is shown with individual functional modules in the schematic diagram and the logical sequences are shown in the flow chart, in some cases, the system can have different modules than those shown and the operations can be executed in a different order than those shown. It should be noted that the terms “first” and “second”, if used in the description, the claims and the drawings are intended to distinguish similar objects, and do not necessarily imply any specific order or sequence.

Provided are a method for charging control, a system, a terminal device, a charger, and a storage medium in some embodiments. According to an embodiment of the present disclosure, a method for charging control is provided. The method is applied to a system for charging control connected with a charger and a battery respectively. The method includes: acquiring maximum charging power value of the charger; acquiring a first current value according to the maximum charging power value and a preset charging data table; where the preset charging data table includes a first plurality of sample cutoff current values and a first plurality of sample cutoff voltage values corresponding to a target battery capacity value; the first current value is the maximum value of current that the charger charged into the battery; determining a target cutoff current value from the first plurality of sample cutoff current values according to the first current value; where the target cutoff current value is less than the first current value; determining a target cutoff voltage value according to the target cutoff current value; where the target cutoff voltage value is a sample cutoff voltage value corresponding to the target cutoff current value; and charging the battery according to the target cutoff current value and the target cutoff voltage value. According to an embodiment of the present disclosure, when the battery is being charged, appropriate cutoff voltage and cutoff current are selected according to the power and current of the charger. The battery is charged according to the target cutoff current value and the target cutoff voltage value. Thus, the amount of electrical charge that is charged into the battery can exactly and fully charge the battery. Thereby, the overcharging or incomplete charging of the battery can be avoided.

According to an embodiment, a method for charging control is provided. The method is applied to a system for charging control that is arranged in a rechargeable device. The method for charging control enables the system for charging control to select an appropriate cutoff voltage and cutoff current according to the power and current of a charger. Thereby, the overcharging or incomplete charging of the battery can be avoided.

According to an embodiment, a method for charging control is provided. The method is applied to a system for charging control that is arranged in a charger. The method for charging control enables the system for charging control to select an appropriate cutoff voltage and cutoff current according to the power and current of a charger. Thereby, the overcharging or incomplete charging of the battery by the charger can be avoided.

According to an embodiment, a method for charging control is provided. The method is applied to a system for charging control. The system for charging control selects an appropriate cutoff voltage and cutoff current, and transfers the voltage and current to a digital circuit arranged on a terminal device. The digital circuit is configured to charge the battery according to the cutoff voltage and cutoff current.

According to an embodiment, a method for charging control is provided. The method is applied to a system for charging control. The system for charging control selects an appropriate cutoff voltage and cutoff current, and transfers the voltage and current to a digital circuit arranged on a charger. The digital circuit is configured to charge the battery according to the cutoff voltage and cutoff current.

The method for charging control according to an embodiment of the present disclosure is applied to a system for charging control connected with the charger and the battery respectively. This indicates that when the battery is charged, the charger, the battery and the system for charging control are connected with each other to prepare for subsequent charging. The system for charging control is connected with the charger and the battery respectively, which does not limit the connection among the charger, the battery and the system for charging control when charging is not carried out. The connection among the charger, the battery and the system for charging control can be mutually or partially separated or connected when charging is not carried out.

The method for charging control according to an embodiment of the present disclosure is applied to a system for charging control which is respectively connected with the charger and the battery. The system for charging control is respectively connected with the charger and the battery. The connection can be wired connection through lines or a wireless connection through signals.

The above embodiments only illustrate the hardware devices to which the technical scheme proposed in present disclosure is applied, and do not limit the technical scheme proposed in present disclosure.

Refer to Table (1), which is a numerical table representing the relationship among cutoff voltage, cutoff current and battery capacity.

TABLE #(1)

| BATTERY | CUTOFF | CUTOFF |
|---|---|---|
| CAPACITY | VOLTAGE | CURRENT |
| 4480 mAh | 4.48 V | 600 mA |
| 4410 mAh | 4.48 V | 800 mA |
| 4380 mAh | 4.48 V | 900 mA |
| 4480 mAh | 4.45 V | 250 mA |
| 4410 mAh | 4.45 V | 400 mA |
| 4380 mAh | 4.45 V | 500 mA |
| 4480 mAh | 4.42 V | 200 mA |
| 4410 mAh | 4.42 V | 300 mA |
| 4380 mAh | 4.42 V | 350 mA |

Referring to Table #(1), when the battery is charged with the same amount of electrical charge, the greater the cutoff voltage value, the greater the cutoff current value, and the faster the charging termination. At the same time, the greater the cutoff voltage and the smaller the cutoff current, the more the electrical charge is charged into the battery. Therefore, overcharging or undercharging may occur when the battery of the terminal device is charged with a charger that does not match the terminal device. Some examples are given below.

Example of battery overcharging. Considering that a battery S1 with a battery capacity of 4410 mAh is provided, which has a corresponding cutoff voltage value of 4.48V and a cutoff current of 800 mA. Also provided is charger A, which can charge battery S1 with an amount of electricity of 4410 mAh at a cutoff voltage value of 4.45V and a cutoff current of 400 mA. When battery S1 is being charged with charger A, the cutoff voltage value is 4.48V and the cutoff current is 800 mA. According to table #(1), the amount of electricity/electrical charge that is charged into the battery is greater than 4480 mAh in this case. As such, the battery S1 is overcharged.

Example of battery undercharging. Considering that a battery S2 with a battery capacity of 4410 mAh is provided, which has a corresponding cutoff voltage value of 4.45V and a cutoff current value of 400 mA. Also provided is charger B, which can charge battery S2 with an amount of electricity of 4410 mAh at a cutoff voltage value of 4.48V and a cutoff current of 800 mA. When battery S2 is being charged with charger B, the cutoff voltage value is 4.45V and the cutoff current is 400 mA. According to table #(1), the amount of electrical charge that is charged into the battery is lower than 4380 mAh in this case. As such, the battery S2 is undercharged.

Several embodiments of the present disclosure will be described in greater detail in conjunction with the drawings.

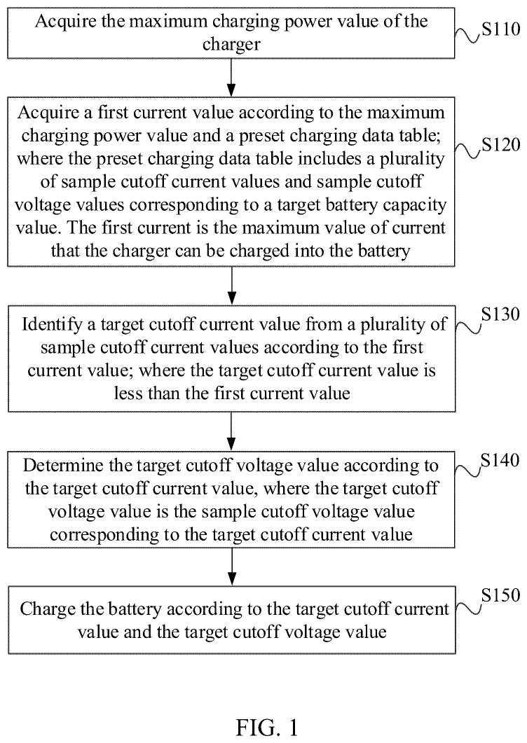

FIG. 1 depicts a flowchart showing a method for charging controll according to an embodiment of the present disclosure. The method is applied to a system for charging controll connected with a charger and a battery respectively. The method includes but is not limited to the following operations.

At operation S110, the maximum charging power value of the charger is acquired.

The maximum charging power of the charger can be obtained according to the type of the charger. For example, for a Universal Serial Bus Power Delivery (USB-PD) charger, the maximum charging power of the charger can be obtained through the USB-PD protocol. For a regular charger, the maximum charging power of the charger can be obtained by power detection. For the charging method through a USB port, the USB port can be utilized as a charger, and the maximum charging power can be obtained directly according to the USB protocol. It shall be noted that the method of how the maximum charging power value of the charger is acquired is not limited by examples, and those having ordinary skills in the art can adjust the method according to the practical situations.

At operation S120, a first current value is obtained according to the maximum charging power value and a preset charging data table. The preset charging data table includes a plurality of sample cutoff current values and sample cutoff voltage values corresponding to a target battery capacity. The first current value is the maximum value of current that the charger can be charged into the battery.

The preset charging data table includes a plurality of sample cutoff current values and sample cutoff voltage values corresponding to the target battery capacity value. The target battery capacity value is an appropriate target battery capacity value comprehensively considered according to the product demand and positioning in a project. The target battery capacity value represents the amount of electricity that can be stored by the battery, which includes the factory battery capacity provided when the battery leaves the factory and the actual battery capacity after the battery is being used.

In an embodiment, referring to Table #(2), the charging data table can be obtained by charging and discharging the battery unit. The charging data table includes cutoff voltage data and cutoff current data corresponding to the battery capacity as shown in Table #(2). The charging data table is employed to determine the target cutoff voltage value and target cutoff current value corresponding to the target battery capacity value in a method for charging control. The cutoff current data and cutoff voltage data corresponding to the target battery capacity value in the charging data table are called sample cutoff voltage value and sample cutoff current value.

TABLE #(2)

| CUTOFF | CUTOFF |
|---|---|
| VOLTAGE | CURRENT |
| Va | Ia |
| Vb | Ib |
| Vc | Ic |

It is noted that the first current value is the maximum current value charged to the battery by the charger, which refers to the current value of the maximum current value that is actually charged to the battery at each unit time. The maximum current value has nothing to do with the current that the charger has charged to the battery.

At operation S130, a target cutoff current value is identified from a plurality of sample cutoff currents according to the first current value. The target cutoff current value is less than the first current value.

In an implementation, the first current value is the maximum current that the charger charged into the battery. A constant voltage charging stage is present when the battery is being charged, only when the target cutoff current value is less than the first current value. Hence, the target cutoff current value should be less than the first current value.

At the same time, all the sample cutoff voltages and sample cutoff currents correspond to the target battery capacity. In case the target cutoff current is less than the first current value, any sample cutoff current is determined as the target cutoff current value, the corresponding sample cutoff voltage value is determined as the target cutoff voltage value, the amount of electrical charge that is charged into the battery can exactly and fully charge the battery under such current and voltage values settings. Thus, the overcharging or incomplete charging of the battery can be avoided. The charging issues in general situations are taken into consideration merely in an embodiment of the present disclosure.

At operation S140, the target cutoff voltage value is determined according to the target cutoff current value, and the target cutoff voltage value is the sample cutoff voltage value corresponding to the target cutoff current value.

In an implementation, when the target cutoff current value has been determined from a plurality of sample cutoff current values according to the first current value, the charging data table can be looked up again. The sample cutoff voltage value corresponding to the target cutoff current value in the charging data table can be determined as the target cutoff voltage value. Alternatively, the corresponding sample cutoff voltage value adjacent to the target cutoff voltage value in the charging data table can be directly read. The determined sample cutoff voltage value can be set as the target cutoff voltage value. Those having ordinary skills in the art can determine the method data acquisition according to the practical situation.

At operation S150, the battery is charged according to the target cutoff current value and the target cutoff voltage value.

Generally, during charging, the time when 100% of battery power is shown on a terminal device is different from the time when the charging ends. The percentage of battery power is generally obtained through an integration of the current with the coulometer. The 100% of the battery power displayed indicates that the battery is fully charged through a prediction by the integration. However, the actual termination of charging is generally judged according to whether the voltage and current of the battery meet the cutoff voltage and current. In general, charging is divided into two stages: constant current charging and constant voltage charging. During constant current charging, the voltage of the battery is lower than the cutoff voltage, and the battery can be charged with constant current. When the battery voltage reaches the cutoff voltage, the charging control system starts the constant-voltage charging, the battery voltage is maintained at the cutoff voltage, and gradually reduces the charging current. When the current is less than the cutoff current, the charging ends to complete the process of charging the battery.

It is well-known to those having ordinary skills in the art to charge the battery according to the target cutoff current and the target cutoff voltage. After the target cutoff current and the target cutoff voltage are determined, those having ordinary skills in the art arrange the charging operations according to the practical situation.

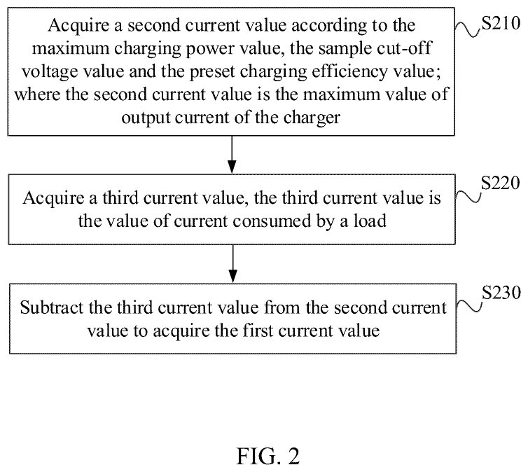

Referring to FIG. 2, in an embodiment, S120 in the embodiment shown in conjunction with FIG. 1 further includes, but is not limited to, the following operations.

At operation S210, a second current value is obtained according to the maximum charging power value, the sample cutoff voltage value and the preset charging efficiency value. The second current value is the maximum value of output current of the charger.

At operation S220, a third current value is acquired. The third current value is the value of current consumed by a load.

At operation S230, the third current value is subtracted from the second current value to acquire the first current value.

In an embodiment, the second current value is the maximum value of output current of the charger, which refers to the maximum output current value that can be generated by the charger. The maximum output current includes the current consumed due to efficiency issues and system load issues.

It shall be noted that the third current value is the current consumed by the load which refers to the average load of the system. The third current value can be set by the relevant developers before charging or calculated according to the relevant data during the historical charging. Those having ordinary skills in the art can find ways to acquire the third current according to the practical situations.

The first current value obtained by subtracting the third current value representing the current consumed by the load from the second current value representing the maximum output current of the charger, is the maximum current that the charger charges to the battery.

The cutoff voltage values and the corresponding sample cutoff currents of each sample in the charging data table are traversed. The sample cutoff voltage value and the corresponding sample cutoff current value in the charging data table that enables the fully charge of the battery are selected. Thereby, the overcharging or the undercharging of the batteries can be addressed.

In an embodiment, the calculation of the first current according to the maximum charging power and the preset charging data table is as follows.

The maximum charging power is denoted as p. The first current value is denoted as Iᵣₑₐₗ. The second current value is denoted as Iₘₐₓ. The third current value is denoted as I_{avg}. The preset charging efficiency is denoted as Effect. The selected sample cutoff current is denoted as I x. The sample cutoff voltage value corresponding to the selected sample cutoff current is denoted as Vx.

Referring to table #(2), the voltage values and current values in table #(2) are traversed. A pair of sample cutoff current I x and sample cutoff voltage value Vx are arbitrarily selected, where x is one of a, b and c. The second current value is acquired according to the maximum charging power value, sample cutoff voltage value and preset charging efficiency value:

$${I}_{max} = \frac{P}{Vx} * Effect$$

The third current value is subtracted from the second current value to obtain the first current value.

$${I}_{real} = {I}_{max} - {I}_{avg}$$

The first current value Iᵣₑₐₗ corresponding to the selected sample cutoff voltage value and the sample cutoff current value are obtained. The first current value should be greater than I x.

When the obtained first current value is not greater than the corresponding sample cutoff current, the sample cutoff current value and sample cutoff voltage value corresponding to the first current value are not subjected to subsequent processing.

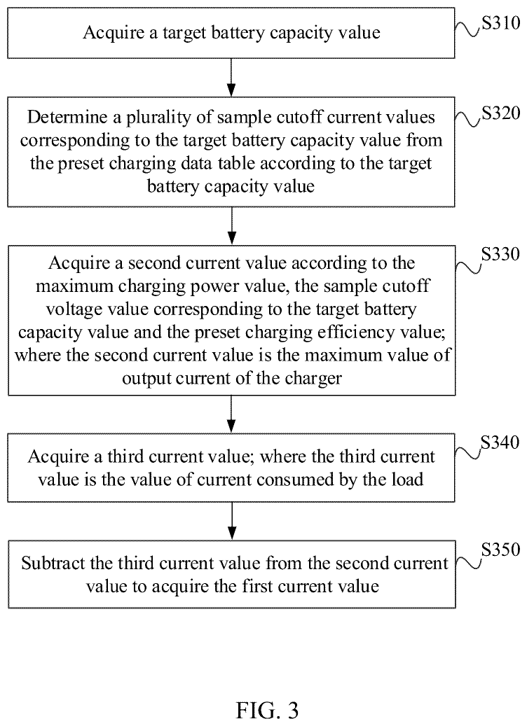

Referring to FIG. 3, in an embodiment, the preset charging data table further includes a plurality of sample cutoff current values and sample cutoff voltage values corresponding to a plurality of non-target battery capacities. Accordingly, operation S120 described in conjunction with the embodiment shown in FIG. 1 includes but is not limited to the following operations.

At operation S310, a target battery capacity value is acquired.

At operation S320, a plurality of sample cutoff current values corresponding to the target battery capacity value are determined from the preset charging data table according to the target battery capacity value.

At operation S330, a second current value is acquired according to the maximum charging power value, the sample cutoff voltage value corresponding to the target battery capacity value and the preset charging efficiency value. The second current value is the maximum value of output current of the charger.

At operation S340, a third current value is acquired. The third current value is the value of current consumed by the load.

At operation S350, the first current value is acquired by subtracting the third current value from the second current value.

Referring to Table #(3) in an embodiment, the preset charging data table further includes a plurality of sample cutoff current values and sample cutoff voltage values corresponding to a plurality of non-target battery capacities.

TABLE #(3)

| BATTERY | CUTOFF | CUTOFF |
|---|---|---|
| CAPACITY | VOLTAGE | CURRENT |
| W1 | Va | Ia1 |
| W2 | Va | Ia2 |
| W3 | Va | Ia3 |
| W1 | Vb | Ib1 |
| W2 | Vb | Ib2 |
| W3 | Vb | Ib3 |
| W1 | Vc | Ic1 |
| W2 | Vc | Ic2 |
| W3 | Vc | Ic3 |

In a project, a comprehensive consideration is made in which, an appropriate target battery capacity is taken as the target battery capacity according to product requirements and positioning. Then subsequent operations are carried out according to the target battery capacity.

In an embodiment, through the charging and discharging test of the battery unit, a point that takes both the fast-charging demand time and the battery life into consideration is found as the cutoff voltage and cutoff current parameters of the standard charger. The actual available capacity value of the battery in this case is taken as the target battery capacity value.

After the target battery capacity value is acquired, a plurality of sample cutoff currents corresponding to the target battery capacity value are determined from the preset charging data table according to the target battery capacity value, so as to prepare for the subsequent determination of the corresponding first current value.

After operation S320, the processing procedures from operation S330 to operation S350 are substantially the same as those from operation S210 to operation S230, and will not be described here again.

In an embodiment, the preset charging data table further includes a plurality of sample cutoff current values and sample cutoff voltage values corresponding to a plurality of non-target battery capacity values. In some embodiments, the calculation of the first current value according to the maximum charging power value and the preset charging data table is as follows.

The maximum charging power is denoted as p. The first current value is denoted as Iᵣₑₐₗ. The second current value is denoted as Iₘₐₓ. The third current value is denoted as I_{avg}. The preset charging efficiency is denoted as Effect. The selected sample cutoff current is denoted as I xy. The sample cutoff voltage value corresponding to the selected sample cutoff current is denoted as Vx.

Referring to Table #(3), in an example, W1 is selected as the target battery capacity. Then the voltage values and current values of Table #(3) are traversed. A pair of sample cutoff current and sample cutoff voltage value corresponding to W1 are arbitrarily selected and taken as I x1 and Vx, where x is one of a, b and c. The second current value is acquired according to the maximum charging power value, sample cutoff voltage value and preset charging efficiency value:

$${I}_{max} = \frac{P}{Vx} * Effect$$

The third current value is subtracted from the second current value to obtain the first current value.

$${I}_{real} = {I}_{max} - {I}_{avg}$$

The first current value Iᵣₑₐₗ corresponding to the selected sample cutoff voltage value and the sample cutoff current value is obtained. The first current value should be greater than I x1.

At the same time, when the obtained first current value is not greater than the corresponding sample cutoff current, the sample cutoff current and sample cutoff voltage value corresponding to the first current value are not subjected to subsequent processing.

It shall be noted that any examples given in the present disclosure are only for better explanation of the technical scheme proposed in the present disclosure, and do not limit the technical scheme proposed in the present disclosure.

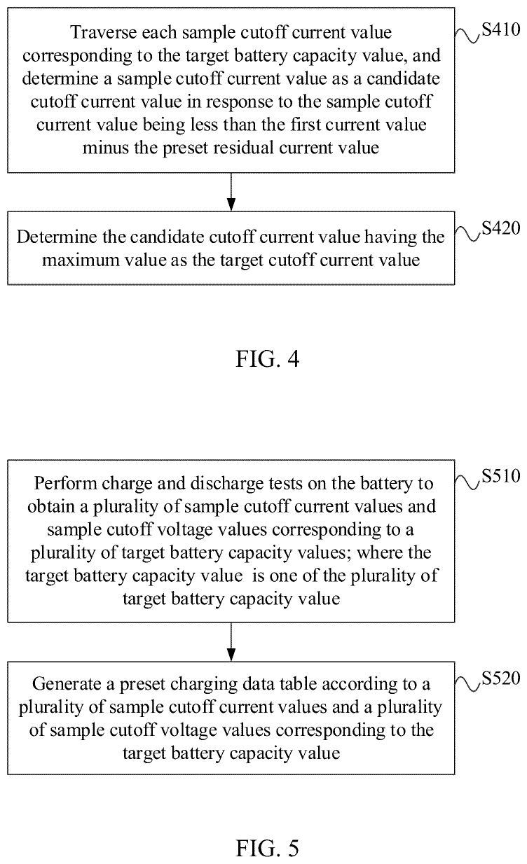

Referring to FIG. 4, in an embodiment, based on the operations of FIG. 2 or FIG. 3, operation S130 of the embodiment shown in FIG. 1 includes but is not limited to the following operations.

At operation S410, each sample cutoff current value corresponding to the target battery capacity value is traversed, and a sample cutoff current value is determined as a candidate cutoff current value in response to the sample cutoff current value being less than or equal to the first current value minus the preset residual current value.

At operation S420, the candidate cutoff current value having the maximum value is determined as the target cutoff current value.

In an implementation, the preset residual current includes the current required by the system for charging control to control charging through cutoff voltage value and cutoff current value and other currents required except charging the battery. When a sample cutoff current is less than or equal to the first current value minus the preset residual current, the sample cutoff current is determined as a candidate cutoff current. Thereby, it is ensured that the candidate cutoff current can keep the preset residual current, and the overcharging or undercharging of the battery is alleviated.

The value of the preset residual current can be determined by those having ordinary skilled in the art according to the practical situations. The preset residual current should be greater than zero.

In an embodiment, operation S410 is expressed as:

$$Ix <= {I}_{real} - Δ I ;$$

where, Iᵣₑₐₗ denotes the first current value, I x denotes the corresponding sample cutoff current, and ΔI denotes the preset residual current.

The traversing of each cutoff current corresponding to the target battery capacity generates a plurality of candidate cutoff currents. These candidate cutoff currents help to alleviate the overcharging or undercharging of the battery. However, the higher the cutoff current, the faster the battery will be fully charged. Therefore, the candidate cutoff current having the maximum value is determined as the target cutoff current. Thereby, the battery can be exactly and fully charged at the fastest speed under the current conditions, thus the user time is saved, and user experience is enhanced.

Referring to FIG. 5, in an embodiment, the generation of the preset charging data table with respect to the embodiment shown in FIG. 1 includes but is not limited to the following operations.

At operation S510, charge and discharge tests are conducted on the battery to obtain a plurality of sample cutoff current values and sample cutoff voltage values corresponding to a plurality of battery capacity values. The plurality of battery capacity values include the target battery capacity value as discussed above.

At operation S520, a preset charging data table is generated according to a plurality of sample cutoff current values and a plurality of sample cutoff voltage values corresponding to the target battery capacity value.

In an implementation, the charge and discharge tests are conventional means for those having ordinary skills in the art to test power parameters. The target battery capacity value is the actual available capacity of the battery corresponding to the case when the battery is charged by users or testers with standard chargers.

According to the different cutoff currents and cutoff voltages during charging, the actual amount of power charged into the battery is also different. During the generation of the equipment, different target battery capacity values can be selected according to the use of the equipment to meet the needs of users for battery capacity in different situations.

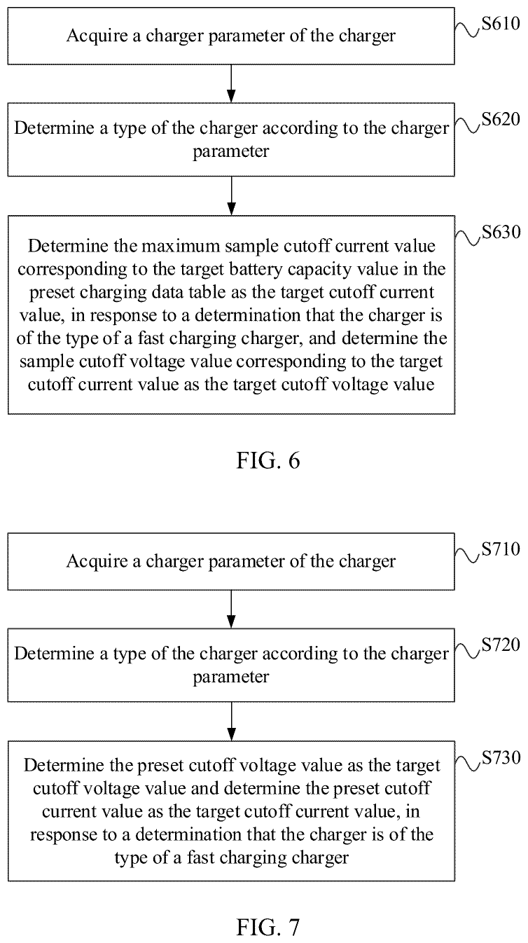

Referring to FIG. 6, in an embodiment, before S110 in the embodiment shown in conjunction with FIG. 1, the method further includes, but is not limited to, the following operations.

At operation S610, a charger parameter of the charger is acquired.

At operation S620, a type of the charger is determined according to the charger parameter.

At operation S630, the maximum sample cutoff current value corresponding to the target battery capacity value in the preset charging data table is determined as the target cutoff current value, in response to a determination that the charger is of the type of a fast charging charger, and the sample cutoff voltage value corresponding to the target cutoff current value is determined as the target cutoff voltage value.

The charging parameters such as charging protocol, supporting current value and supporting current value of the charger can be obtained by reading the protocol and charging test. The type of charger can be determined according to the obtained charger parameters. The acquisition of the charger parameters and the determination of the type of the charger according to the charger parameters are well-known to those having ordinary skills in the art, and will not be described in greater detail here.

In an embodiment, the charger may be the type of a fast-charging charger or a non-fast-charging charger. Whether the charger is a fast-charging charger can be determined according to preset conditions. For example, in general, PD chargers and QC (Quick Charge) chargers are determined as fast-charging chargers. For regular chargers, chargers that support current output above 2 A are determined as fast-charging chargers, and relatively, regular chargers or USB chargers that support current below 2 A are determined as non-fast-charging chargers. The above examples only illustrate the method operations of the present disclosure, and do not limit the present disclosure. Those having ordinary skills in the art can adjust the conditions for judging whether the charger is fast charging according to the practical situations.

In an embodiment, the charger is of the type of a fast-charging charger, which means that the charger can perform the charging with the preset optimal target cutoff voltage value and target cutoff current value. Therefore, the maximum sample cutoff current corresponding to the battery capacity in the preset charging data table is determined as the target cutoff current, and the sample cutoff voltage corresponding to the target cutoff current is determined as the target cutoff voltage value. As such, the optimal cutoff voltage value and cutoff current value can be applied to the fast-charging charger. The slow charging of the fast-charging charger due to unsuitable cutoff voltage value and cutoff current value can be alleviated. The charging is speeded up, and the user experience is enhanced.

Referring to FIG. 7, in an embodiment, before S110 in the embodiment shown in conjunction with FIG. 1, the method further includes, but is not limited to, the following operations.

At operation S710, a charger parameter of the charger is acquired.

At operation S720, a type of the charger is determined according to the charger parameter.

At operation S730, the preset cutoff voltage value is determined as the target cutoff voltage value and the preset cutoff current value is determined as the target cutoff current value, in response to a determination that the charger is of the type of a fast-charging charger.

The process from operation S710 to operation S720 is essentially the same as the process from operation S610 to operation S620 and will not be repeated here.

It shall be noted that, in an embodiment, in case that the charger is of the type of a fast charging charger, it is indicated that the charger can charge with the target cutoff voltage value and target cutoff current value corresponding to the preset fast charging configuration. Therefore, the preset cutoff voltage value is determined as the target cutoff voltage value, and the preset cutoff current is determined as the target cutoff current. The corresponding cutoff voltage value and cutoff current value set in advance are applied to the fast charging charger. Thereby, the occurrence of the limitation on the charging speed of the fast charging charger due to the improper cutoff voltage value and cutoff current value is reduced, the charging speed is increased and the user experience is enhanced.

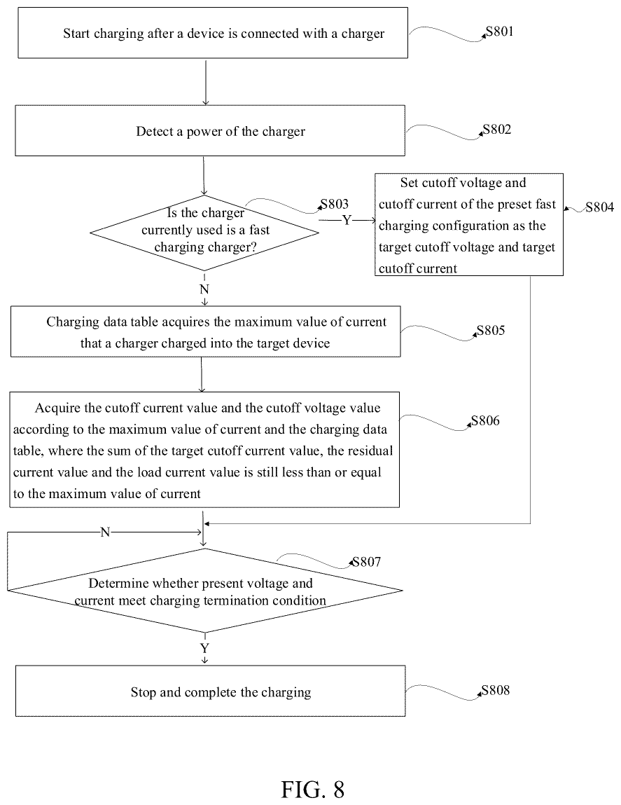

FIG. 8 depicts an example diagram showing a charging control by a method for charging control according to yet another embodiment of the present disclosure. The method includes but is not limited to the following operations.

At operation S801, charging is started after a device is connected with a charger.

At operation S802, the power of the charger is detected.

At operation S803, a determination is performed as to whether the currently used charger is a fast-charging charger, if so, operation S804 is performed, and if not, operation S805 is performed.

At operation S804, the cutoff voltage value and cutoff current value of the preset fast charging configuration are set as the target cutoff voltage value and target cutoff current value.

At operation S805, the charging data table acquires the maximum value of current that a charger charged into the target device.

At operation S806, the cutoff current value and the cutoff voltage value are obtained according to the maximum value of current and the charging data table, and the sum of the target cutoff current value, the residual current value and the load current value is still less than or equal to the maximum value of current.

At operation S807, a determination is performed as to whether the present voltage and current values meet the charging termination condition, if so, operation S808 is performed, and if not, operation S807 is performed.

At operation S808, the charging is stopped and completed.

Referring to the data in Table #(1), it is assumed that the fast-charging configuration of the device is cutoff voltage value of 4.48V and cutoff current of 800 mA, and the corresponding battery capacity of the device is 4410 mAh. For example, when the device is charged by USB connection, the maximum power of USB connection is 2.5 W (0.5 A, 5V), and the maximum current value charged by the charger to the target device is estimated to be below 500 mA. However, considering that the load current generated by the average load of the system is about 100 mA, and the residual current of 100 mA needs to be kept, it is necessary to choose the cutoff voltage value of 4.42V and the cutoff current of 300 mA. The device is charged until the charging ends and is completed.

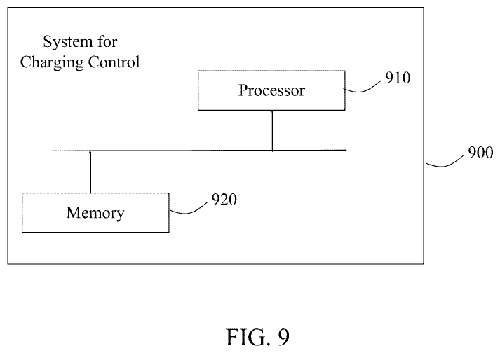

Referring to FIG. 9, according to an embodiment of the present disclosure, a system for charging control 900 is provided. The system includes a memory 920, a processor 910 and a computer program stored in the memory 920 and executable by the processor 910 which, when executed by the processor 910, causes the processor 910 to carry out the method for charging control described in any one of the embodiments above, for example, the above operations S110 to S150 described in conjunction with FIGS. 1, S210 to S230 described in conjunction with FIGS. 2, S310 to S350 described in conjunction with FIGS. 3, S410 to S420 described in conjunction with FIGS. 4, S510 to S520 described in conjunction with FIGS. 5, S610 to S630 described in conjunction with FIGS. 6, S710 to S730 described in conjunction with FIG. 7, or S801 to S808 described in conjunction with FIG. 8.

According to yet another embodiment of the present disclosure, a device is provided. The device includes the system for charging control 900 described in conjunction with FIG. 9 abovewhich can carry out the method for charging control described in any one of the embodiments above, for example, the above operations S110 to S150 described in conjunction with FIGS. 1, S210 to S230 described in conjunction with FIGS. 2, S310 to S350 described in conjunction with FIGS. 3, S410 to S420 described in conjunction with FIGS. 4, S510 to S520 described in conjunction with FIGS. 5, S610 to S630 described in conjunction with FIGS. 6, S710 to S730 described in conjunction with FIG. 7, or S801 to S808 described in conjunction with FIG. 8.

According to yet another embodiment of the present disclosure, a charger is provided. The charger includes the system for charging control 900 described in conjunction with FIG. 9 above, which can carry out the method for charging control described in any one of the embodiments above, for example, the above operations S110 to S150 described in conjunction with FIGS. 1, S210 to S230 described in conjunction with FIGS. 2, S310 to S350 described in conjunction with FIGS. 3, S410 to S420 described in conjunction with FIGS. 4, S510 to S520 described in conjunction with FIGS. 5, S610 to S630 described in conjunction with FIGS. 6, S710 to S730 described in conjunction with FIG. 7, or S801 to S808 described in conjunction with FIG. 8.

According to yet another embodiment of the present disclosure, there is provided a computer-readable storage medium, which stores computer-executable instructions which, when executed by a processor or controller, causes the processor or controller to carry out the operations of the method described above, for example, the above-described operations S110 to S150 described in conjunction with FIG. 1, S210 to S230 described in conjunction with FIG. 2, S310 to S350 described in conjunction with FIG. 3, S410 to S420 described in conjunction with FIG. 4; or S510 to S520 described in conjunction with FIG. 5, S610 to S630 described in conjunction with FIG. 6, S710 to S730 described in conjunction with FIG. 7, or S801 to S808 described in conjunction with FIG. 8.

Provided are a method for charging control, a system, a terminal device, a charger, and a storage medium in some embodiments. According to an embodiment of the present disclosure, a method for charging control is provided. The method is applied to a system for charging control connected with a charger and a battery respectively. The method includes: acquiring maximum charging power value of the charger; acquiring a first current value according to the maximum charging power value and a preset charging data table; where the preset charging data table includes a first plurality of sample cutoff current values and a first plurality of sample cutoff voltage values corresponding to a target battery capacity value; the first current value is the maximum value of current that the charger charged into the battery; determining a target cutoff current value from the first plurality of sample cutoff current values according to the first current value; where the target cutoff current value is less than the first current value; determining a target cutoff voltage value according to the target cutoff current value; where the target cutoff voltage value is a sample cutoff voltage value corresponding to the target cutoff current value; and charging the battery according to the target cutoff current value and the target cutoff voltage value. Thereby, the charge that is charged into the battery can exactly and fully charge the battery. Thus, the overcharging or undercharging of the battery can be avoided.

It shall be appreciated by a person having ordinary skills in the art that all or some of the operations and systems disclosed above can be implemented as software, firmware, hardware and their appropriate combinations. Some or all physical components can be implemented as software executed by a processor, such as a central processing unit, a digital signal processor or a microprocessor, or as hardware, or as an integrated circuit, such as an application specific integrated circuit. Such software can be distributed on computer-readable media, which can include computer storage media (or non-transitory media) and communication media (or transitory media). As is well known to a person having ordinary skills in the art, the term computer storage medium includes volatile and nonvolatile, removable and non-removable medium implemented in any method or technology for storing information such as computer readable instructions, data structures, program modules or other data. Computer storage medium includes, but is not limited to, RAM, ROM, EEPROM, flash memory or other memory technologies, CD-ROM, digital versatile disks (DVD) or other optical disk storage, magnetic boxes, tapes, magnetic disk storage or other magnetic storage devices, or any other medium that can be configured to store desired information and accessible by a computer. Furthermore, it is well known to those having ordinary skills in the art that communication media usually contains computer-readable instructions, data structures, program modules or other data in modulated data signals such as carrier waves or other transmission mechanisms, and can include any information delivery media.

Described above is a description for several embodiments of the present disclosure, but the present disclosure is not limited to the above embodiments. Those having ordinary skills in the art can make various equivalent modifications or substitutions without departing the scope of the present disclosure, and these equivalent modifications or substitutions are within the scope defined by the claims of the present disclosure.

1. A method for charging control, applied to a system for charging control connected with a charger and a battery respectively, the method comprising:
acquiring maximum charging power value of the charger;
acquiring a first current value according to the maximum charging power value and a preset charging data table; wherein the preset charging data table comprises a first plurality of sample cutoff current values and a first plurality of sample cutoff voltage values corresponding to a target battery capacity value; and the first current value is a maximum value of current that the charger charged into the battery;
determining a target cutoff current value from the first plurality of sample cutoff current values according to the first current value; wherein the target cutoff current value is less than the first current value;
determining a target cutoff voltage value according to the target cutoff current value; wherein the target cutoff voltage value is one sample cutoff voltage value corresponding to the target cutoff current value, among the first plurality of sample cutoff voltage values; and
charging the battery according to the target cutoff current value and the target cutoff voltage value.

2. The method as claimed in claim 1, wherein acquiring the first current value according to the maximum charging power value and the preset charging data table comprises:
acquiring a second current value according to the maximum charging power value, the sample cutoff voltage value and a preset charging efficiency value; wherein the second current value is a maximum value of output current of the charger;
acquiring a third current value; wherein the third current value is a value of current consumed by a load; and
subtracting the third current value from the second current value to acquire the first current value.

3. The method as claimed in claim 1, wherein the preset charging data table further comprises a second plurality of sample cutoff current values and a second plurality of sample cutoff voltage values corresponding to a plurality of non-target battery capacity values, and acquiring the first current value according to the maximum charging power value and the preset charging data table comprises:
acquiring a target battery capacity value;
identifying the first plurality of sample cutoff current values corresponding to the target battery capacity value from the preset charging data table according to the target battery capacity value;
acquiring a second current value according to the maximum charging power value, the sample cutoff voltage value corresponding to the target battery capacity value and a preset charging efficiency value; wherein the second current value is a maximum value of output current of the charger;
acquiring a third current value; wherein the third current value is a value of current consumed by a load; and
subtracting the third current value from the second current value to acquire the first current value.

4. The method as claimed in claim 2, wherein determining the target cutoff current value from the first plurality of sample off current values according to the first current value comprises:
traversing each of the first plurality of sample cutoff current values corresponding to the target battery capacity, and determining each of at least one sample cutoff current value among the first plurality of sample cutoff current values, as a candidate cutoff current value, in response to each of the at least one sample cutoff current being less than or equal to the first current value minus a preset residual current value; and
determining the candidate cutoff current value having maximum value as the target cutoff current value.

5. The method as claimed in claim 1, wherein the preset charging data table is generated by:
performing charge and discharge tests on the battery to acquire the first plurality of sample cutoff current values and the first plurality of sample cutoff voltage values corresponding to a plurality of battery capacity values; wherein
the plurality of battery capacity values comprise the target battery capacity value; and
generating the preset charging data table according to the first plurality of sample cutoff current values and the first plurality of sample cutoff voltage values corresponding to the target battery capacity value.

6. The method as claimed in claim 1, wherein before acquiring the maximum charging power value of the charger, the method further comprises:
acquiring a charger parameter of the charger;
determining a type of the charger according to the charger parameter; and
determining one sample cutoff current value having the maximum value corresponding to the target battery capacity value, among the first plurality of sample cutoff current values in the preset charging data table, as the target cutoff current value, in response to a determination that the charger is of the type of a fast-charging charger, and determining one sample cutoff voltage value corresponding to the target cutoff current value, among the first plurality of sample cutoff voltage values, as the target cutoff voltage value.

7. The method as claimed in claim 1, wherein before acquiring the maximum charging power value of the charger, the method further comprises:
acquiring a charger parameter of the charger;
determining a type of the charger according to the charger parameter; and
determining a preset cutoff voltage value as the target cutoff voltage value, and determining a preset cutoff current value as the target cutoff current value, in response to a determination that the charger is of the type of a fast charging charger.

8. A system for charging control, comprising a memory, a processor and a computer program stored in the memory and executable by the processor which, when executed by the processor, causes the processor to carry out a method for charging control, applied to the system for charging control connected with a charger and a battery respectively, the method comprising:
acquiring maximum charging power value of the charger;
acquiring a first current value according to the maximum charging power value and a preset charging data table; wherein
the preset charging data table comprises a first plurality of sample cutoff current values and a first plurality of sample cutoff voltage values corresponding to a target battery capacity value; and
the first current value is a maximum value of current that the charger charged into the battery;
determining a target cutoff current value from the first plurality of sample cutoff current values according to the first current value; wherein
the target cutoff current value is less than the first current value;
determining a target cutoff voltage value according to the target cutoff current value; wherein
the target cutoff voltage value is one sample cutoff voltage value corresponding to the target cutoff current value, among the first plurality of sample cutoff voltage values; and
charging the battery according to the target cutoff current value and the target cutoff voltage value.

9. A terminal device, comprising the system as claimed in claim 8.

10. A charger, comprising the system as claimed in claim 8.

11. A non-transitory computer-readable storage medium storing a computer-executable instruction which, when executed by a processor, causes the processor to carry out a method for charging control, applied to a system for charging control connected with a charger and a battery respectively, the method comprising:
acquiring maximum charging power value of the charger;
acquiring a first current value according to the maximum charging power value and a preset charging data table; wherein
the preset charging data table comprises a first plurality of sample cutoff current values and a first plurality of sample cutoff voltage values corresponding to a target battery capacity value; and
the first current value is a maximum value of current that the charger charged into the battery;
determining a target cutoff current value from the first plurality of sample cutoff current values according to the first current value; wherein
the target cutoff current value is less than the first current value;
determining a target cutoff voltage value according to the target cutoff current value; wherein
the target cutoff voltage value is one sample cutoff voltage value corresponding to the target cutoff current value, among the first plurality of sample cutoff voltage values; and
charging the battery according to the target cutoff current value and the target cutoff voltage value.

12. The method as claimed in claim 3, wherein determining the target cutoff current value from the first plurality of sample off current values according to the first current value comprises:
traversing each of the first plurality of sample cutoff current values corresponding to the target battery capacity, and determining each of at least one sample cutoff current value among the first plurality of sample cutoff current values, as a candidate cutoff current value, in response to each of the at least one sample cutoff current being less than or equal to the first current value minus a preset residual current value; and
determining the candidate cutoff current value having maximum value as the target cutoff current value.

13. The system as claimed in claim 8, wherein acquiring the first current value according to the maximum charging power value and the preset charging data table comprises:
acquiring a second current value according to the maximum charging power value, the sample cutoff voltage value and a preset charging efficiency value; wherein
the second current value is a maximum value of output current of the charger;
acquiring a third current value; wherein
the third current value is a value of current consumed by a load; and
subtracting the third current value from the second current value to acquire the first current value.

14. The system as claimed in claim 8, wherein the preset charging data table further comprises a second plurality of sample cutoff current values and a second plurality of sample cutoff voltage values corresponding to a plurality of non-target battery capacity values, and acquiring the first current value according to the maximum charging power value and the preset charging data table comprises:
acquiring a target battery capacity value;
identifying the first plurality of sample cutoff current values corresponding to the target battery capacity value from the preset charging data table according to the target battery capacity value;
acquiring a second current value according to the maximum charging power value, the sample cutoff voltage value corresponding to the target battery capacity value and a preset charging efficiency value; wherein
the second current value is a maximum value of output current of the charger;
acquiring a third current value; wherein
the third current value is a value of current consumed by a load; and
subtracting the third current value from the second current value to acquire the first current value.

15. The system as claimed in claim 13, wherein determining the target cutoff current value from the first plurality of sample off current values according to the first current value comprises:
traversing each of the first plurality of sample cutoff current values corresponding to the target battery capacity, and determining each of at least one sample cutoff current value among the first plurality of sample cutoff current values, as a candidate cutoff current value, in response to each of the at least one sample cutoff current being less than or equal to the first current value minus a preset residual current value; and
determining the candidate cutoff current value having maximum value as the target cutoff current value.

16. The system as claimed in claim 8, wherein the preset charging data table is generated by:
performing charge and discharge tests on the battery to acquire the first plurality of sample cutoff current values and the first plurality of sample cutoff voltage values corresponding to a plurality of battery capacity values; wherein
the plurality of battery capacity values comprise the target battery capacity value; and
generating the preset charging data table according to the first plurality of sample cutoff current values and the first plurality of sample cutoff voltage values corresponding to the target battery capacity value.

17. The system as claimed in claim 8, wherein before acquiring the maximum charging power value of the charger, the method further comprises:
acquiring a charger parameter of the charger;
determining a type of the charger according to the charger parameter; and
determining a preset cutoff voltage value as the target cutoff voltage value, and determining a preset cutoff current value as the target cutoff current value, in response to a determination that the charger is of the type of a fast charging charger.

18. The non-transitory computer-readable storage medium as claimed in claim 11, wherein acquiring the first current value according to the maximum charging power value and the preset charging data table comprises:
acquiring a second current value according to the maximum charging power value, the sample cutoff voltage value and a preset charging efficiency value; wherein
the second current value is a maximum value of output current of the charger;
acquiring a third current value; wherein
the third current value is a value of current consumed by a load; and
subtracting the third current value from the second current value to acquire the first current value.

19. The non-transitory computer-readable storage medium as claimed in claim 11, wherein the preset charging data table further comprises a second plurality of sample cutoff current values and a second plurality of sample cutoff voltage values corresponding to a plurality of non-target battery capacity values, and acquiring the first current value according to the maximum charging power value and the preset charging data table comprises:
acquiring a target battery capacity value;
identifying the first plurality of sample cutoff current values corresponding to the target battery capacity value from the preset charging data table according to the target battery capacity value;
acquiring a second current value according to the maximum charging power value, the sample cutoff voltage value corresponding to the target battery capacity value and a preset charging efficiency value; wherein
the second current value is a maximum value of output current of the charger;
acquiring a third current value; wherein
the third current value is a value of current consumed by a load; and
subtracting the third current value from the second current value to acquire the first current value.

20. The non-transitory computer-readable storage medium as claimed in claim 18, wherein determining the target cutoff current value from the first plurality of sample off current values according to the first current value comprises:
traversing each of the first plurality of sample cutoff current values corresponding to the target battery capacity, and determining each of at least one sample cutoff current value among the first plurality of sample cutoff current values, as a candidate cutoff current value, in response to each of the at least one sample cutoff current being less than or equal to the first current value minus a preset residual current value; and
determining the candidate cutoff current value having maximum value as the target cutoff current value.
